(19) United States
(12) Patent Application Publication
(10) Pub. No.: US 2006/0219349 A1
(43) Pub. Date: Oct. 5, 2006

(54) Adhesive tape joining method and adhesive tape joining jig using the same

(75) Inventors: Osamu Degawa, Osaka (JP); Kazuhiko Kinpara, Osaka (JP); Shinsuke Ikishima, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: Nitto Denko Corporation

(21) Appl. No.: 11/391,298

(22) Filed: Mar. 29, 2006

(30) Foreign Application Priority Data
Apr. 1, 2005 (JP) JP2005-106291

(51) Int. Cl. B32B 37/00; B29C 51/16; B65B 51/06

(52) U.S. Cl. 156/212; 156/216; 156/461; 156/468; 156/475; 156/486

(57) ABSTRACT

A jig main body is engaged with and guided to an edge side of a workpiece to be moved along a longitudinal direction of the workpiece. Herein, a tape portion protruded from the workpiece is folded back while being pressed by a first pressing part provided to the jig main body prior to a top of the edge side. Then, the folded tape portion is pressed by a second pressing part provided to the jig main body subsequent to a back face of the edge side.

### BACKGROUND OF THE INVENTION

(1) Field of the Invention

The present invention relates to an adhesive tape joining method used when an adhesive tape is joined to a workpiece such as a door sash or the like of an automobile, and an adhesive tape joining jig using this method.

(2) Description of the Related Art

In recent years, in a manufacturing process of an automobile, in place of black coating processing on a door sash, a technology to join a black adhesive tape has been developed. Using this technology, the black and wide adhesive tape is joined along a main side face that is an exterior of a workpiece, and then, the protruded portion of the adhesive tape is folded back and joined along the edge side of the workpiece.

According to the means for folding back and joining the protruded portion of the adhesive tape along the edge side of the workpiece, for example, joining is carried out while manually pushing a jig main body engaged with and guided to the workpiece along the workpiece. Specifically, it is suggested that a front-and-back pair of rollers formed in the shape of a hand drum that is provided to the jig main body is rolled and pressed on a top face and a rear face at the edge side of the workpiece (refer to JP-A 2002-211832).

However, in the above-described joining means, one place in a circumferential direction in the hand-drum shaped roller is opposed to the top face and the back face of the edge side, so that pressing the protruded portion of the adhesive tape on the top face of the edge side and pressing the folded tape portion on the back face of the edge side are carried out at the same time. Accordingly, when a head roller presses the protruded portion of the adhesive tape at first, the adhesive tape is joined on the back face until air tangled inward in accordance with folding of the tape has completely escaped. As a result, this involves a problem such that air bubble remains near the top of the edge side.

Such a phenomenon becomes remarkable the more the jig is quickly moved forward. In addition, in order to remove remaining of air bubble due to tangling, it is necessary to slowly move the jig forward and to secure a time for air relief. In other words, according to the conventional joining means, it is not possible to move the jig forward too quickly, and this leads to a disadvantage that the improvement of the operating efficiency is difficult.

### SUMMARY OF THE INVENTION

The present invention has been made taking the foregoing problems into consideration, and an object thereof is to provide an adhesive tape joining method that can fold back and join an adhesive tape to an edge side with high efficiency without generating remaining of air bubble due to tangling, and an adhesive tape joining jig using this method.

In order to attain such an object, the present invention employs the following configuration.

An adhesive tape joining method for folding back a protruded portion of an adhesive tape joined on an adhesive tape joining target face of a workpiece along an edge side of the workpiece and joining the protruded portion to the workpiece, the method comprising the steps of:

engaging and guiding a jig main body with and to the edge side of the workpiece to move the jig main body along the workpiece; and

folding back the tape portion protruded from the workpiece while pressing the tape portion by a first pressing part provided to the jig main body prior to a top of the edge side and, then, pressing the folded tape portion against a back face of the edge side by a second pressing part provided to the jig main body.

According to the adhesive tape joining method of the present invention, the protruded tape portion is folded back while being pressed prior to the top of the edge side by the first pressing part. Therefore, the tangled air is discharged from the top to the back face side of the edge side. Then, the folded tape portion is joined to the back face of the edge side by the second pressing part, so that air discharged to the back face side is pushed out from the joined face outside to be removed. In other words, the folding back and joining are carried out without remaining of air bubble.

In this case, despite of the forward moving speed of the jig main body, pushing out and removing of air bubble from the top of the edge side is always prioritized. As a result, even if the jig main body is quickly moved forward, it is possible to efficiently fold back and join the tape with no air bubble remained due to tangling.

As a specific joining method, the followings are considered.

First, a guide pressing part provided to the jig main body is engaged with and acted on an adhesive tape joining target face of the workpiece and, also, this guide pressing part and the second pressing part are displaced in the back and forth in the direction of moving the jig to sandwich and press the edge side of the workpiece from the both sides.

Second, the jig main body is provided with a guide groove that is externally fitted to and engaged with the edge side, this guide groove has a narrow constricted part at the back-and-forth middle part, and the guide groove is formed in the shape of a hand drum that is opened with its back-and-forth part widened, the bottom face of the guide groove is made into the first pressing part, and this first pressing part is engaged with and acted on the adhesive tape joining target face of the workpiece, one of the groove inside faces at the front part of the constricted part is made into the guide pressing part, and the guide pressing part and the second pressing part are displaced in the back and forth in the direction of moving the jig to sandwich and press the edge side of the workpiece from the both sides.

According to the first method, the second pressing part is pressed on the back face of the edge side of the workpiece and the jig main body is moved forward in a forward direction with a twisting force given thereto so that the guide pressing part is pressed against the target face of the workpiece. In other words, the workpiece is sandwiched from the opposite faces and even and well-finished joining can be continuously carried out while maintaining the jig main body at a stable posture and smoothly moving it.

In addition, in order to attain such an object, the present invention may be configured as follows.

An adhesive tape joining jig for convoluting a protruded portion of an adhesive tape joined to an adhesive tape joining target face of a workpiece along an edge side of the workpiece and joining the protruded portion to the workpiece, the jig comprising:

a first pressing part opposed to a top of an edge side, which manually moves a jig main body along the edge side being engaged with the edge side of the workpiece;

a second pressing part opposed to a back face of the edge side of the workpiece; and

a guide pressing part opposed to the adhesive tape joining target face of the workpiece, wherein

the first pressing part and the guiding pressing part are arranged at the part of the direction of moving the jig ahead of the second pressing part.

According to the adhesive tape joining jig of the present invention, it is possible to preferably practice the above-described method of the invention.

Preferably, the jig main body is provided with a guide groove externally fitted to and engaged with the edge side, this guide groove has a narrow constricted part at the back-and-forth middle part, and the guide groove is formed in the shape of a hand drum that is opened with its back-and-forth part widened, the bottom face of the guide groove is formed on the first pressing part, one of the groove inside faces at the front part of the constricted part is formed on the guide pressing part, and the other of the groove inside faces at the rear part of the constricted part is formed on the second pressing part.

According to this structure, only by forming a groove shaped in a hand drum on one face of the jig main body shaped in a block made of, for example, a hard resin material, it is possible to inexpensively manufacture the adhesive tape joining jig by which the above-described method can be practiced by a very simple structure without no roller and no spindle. In other words, this adhesive tape joining jig is very excellent in a practical advantage.

In addition, preferably, the jig main body is provided with a guide groove externally fitted to and engaged with the edge side, this guide groove has a narrow constricted part at the back-and-forth middle part, and the guide groove is formed in the shape of a hand drum that is opened with its back-and-forth part widened, the bottom face of the guide groove is made into the first pressing part, further, one of the groove inside faces at the front part of the constricted part is made into a guiding roller that can freely idle, the other of the groove inside faces at the rear part of the constricted part is provided with a rear part roller that can freely idle, and the guiding roller and the rear part roller are displaced in the back and forth in the direction of moving the jig to sandwich and press the edge side of the workpiece from the both sides.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view seen from the side of a joining operation face of an adhesive tape joining jig;

FIG. 2 is a perspective view showing a workpiece and the adhesive tape joining jig;

FIG. 3 is perspective view showing a folding back and joining step;

FIG. 4 is a cross sectional view of a substantial part that is prepared for joining;

FIG. 5 is a cross sectional view of a folding back and joining step;

FIG. 6 is a sectional view taken along an X-X line in FIG. 5; and

FIG. 7 is a plan view of a jig according to a modification.

### DESCRIPTION OF THE PREFERRED EMBODIMENTS

Embodiments of the present invention will be described below with reference to the drawings.

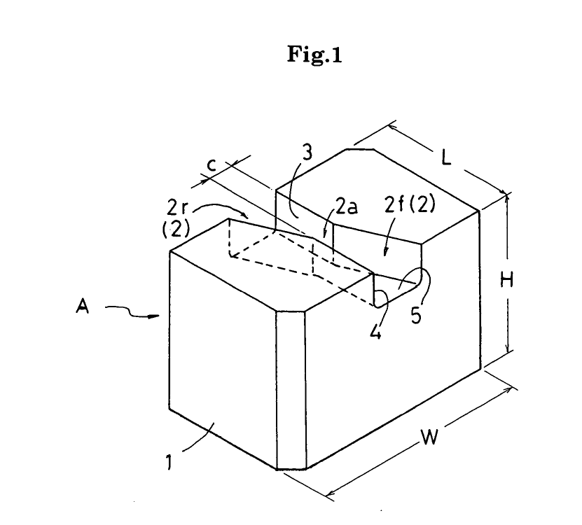

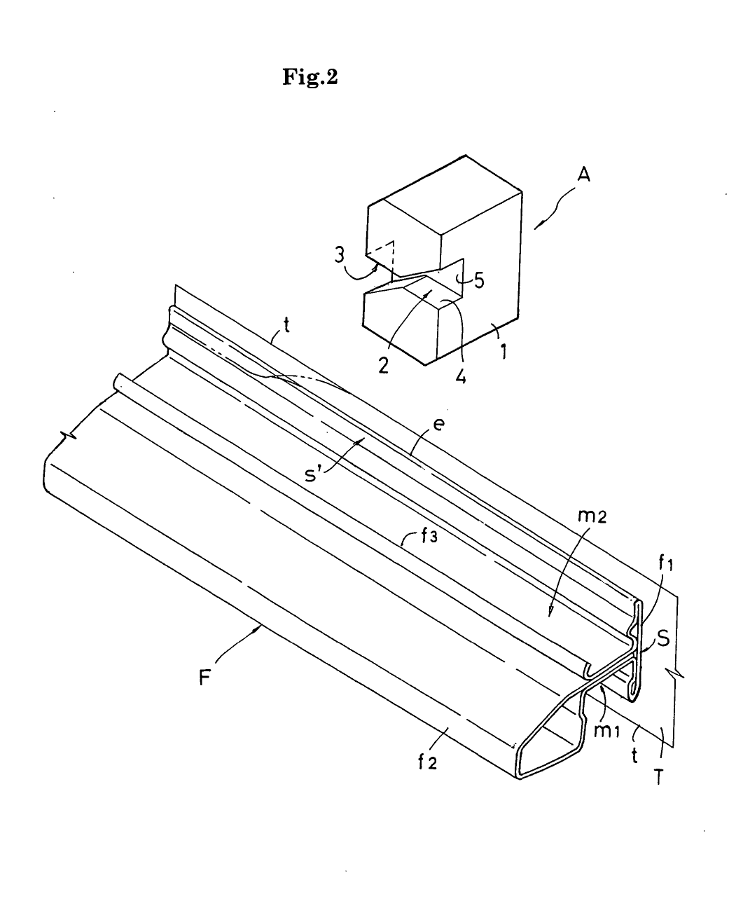

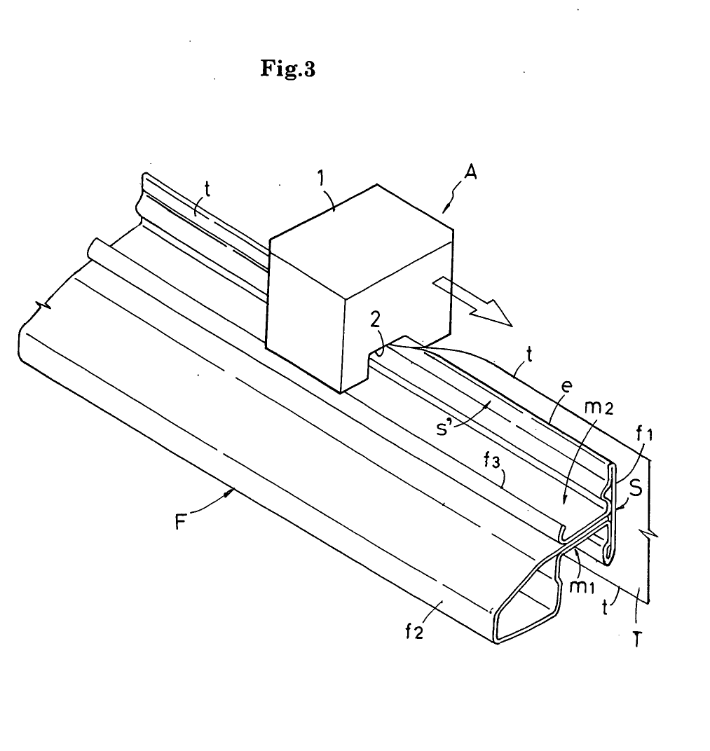

FIG. 1 is a perspective view of an adhesive tape joining jig A according to the present invention, FIG. 2 is a perspective view of a workpiece F and the adhesive tape joining jig A, and FIGS. 3 to 6 are perspective views each showing a step of folding back an adhesive tape T and joining the adhesive tape T to the workpiece F.

Herein, the workpiece F according to this embodiment is a door sash in an automobile, and in place of black coating processing, a black adhesive tape T is joined on a main side face S that is an exterior of the workpiece F.

The workpiece F, as shown in FIG. 2, is configured by press polymerization of a single steel plate. This workpiece F has an outer frame f₁ shaped in a longitudinal wall at the lateral outside that is the outer face of the door, and the workpiece F is formed with a section that a hollow lateral frame f₂ thrusting from this outer frame f₁ toward the inside of the door is connected.

Then, between a hollow region of the lateral frame f₂ and the outer frame f₁, a window glass mounting groove m₁ is formed. In addition, at right and left middle region of the outer face of the lateral frame f₂ (the upper face in the drawing), a lib f₃ is protruded along the longitudinal direction of the workpiece. Between this lib f₃ and the outer frame f₁, a weather strip mounting groove m₂ is formed. Then, a main side face S of the outer frame f₁ becomes a tape joining face.

As the adhesive tape T, an adhesive tape with a separator that is wider than the tape joining face S is used. This adhesive tape T is joined to the tape joining face S being positioned so as to protrude from upper and lower edge sides e at the outer frame f₁ by several mm, respectively. Further, for joining the adhesive tape onto this tape joining face S, a joining jig for exclusive use is used, and the tape is joined manually.

A tape portion t protruded from the tape joining face S is folded back along the edge side e in a subsequent step to be joined to its back face s′. This folding and joining will be made by using the adhesive tape joining jig A according to the present invention as follows.

As shown in FIG. 1, a jig main body 1 of the adhesive tape joining jig A is formed by a hard resin material that is excellent in a slipping property. The jig main body 1 is formed in a block with a cross direction length L, about 20 mm; a right and left width W, about 30 and some mm; and a height H, about 20 and some mm. At its joining operation face (the lower face in FIG. 3), a guide groove 2 of a depth several mm across the back-and-forth of the main body 1 is formed. Further, in the adhesive tape joining jig A, the face contacting the adhesive tape T may be excellent in a slipping property. For example, fluorine coating may be applied on the jig main body, or the jig main body itself may be configured by a fluorine resin.

This guide groove 2 has a narrow constricted part 2a at the back-and-forth middle part, and the guide groove 2 is formed in the shape of a hand drum that is opened with its back-and-forth part widened. In addition, one inside face 3 of a widened groove 2r at the rear part of the constricted part 2a and the other inside face 4 of a widened groove 2f at the front part of the constricted part 2a are formed in parallel each other along the back-and-front direction, respectively. In addition, an interval c between these both inside faces 3 and 4, namely, the right and left directional interval of the constricted part 2a is set to be a measurement adding twice of the tape thickness to the thickness of the edge side e, or to be slightly larger than this measurement.

Then, a bottom face 5 of the guide groove 2 is formed at the first pressing part opposed to the top of the edge side e of the workpiece F, the inside face 3 at the rear side is formed at the second pressing part opposed to the back face s′ of the edge side e, and the inside face 4 of the front side is formed at the guide pressing part opposed to the joining face S of the workpiece F.

The adhesive tape joining jig A is configured as follows and it is used in the following manner.

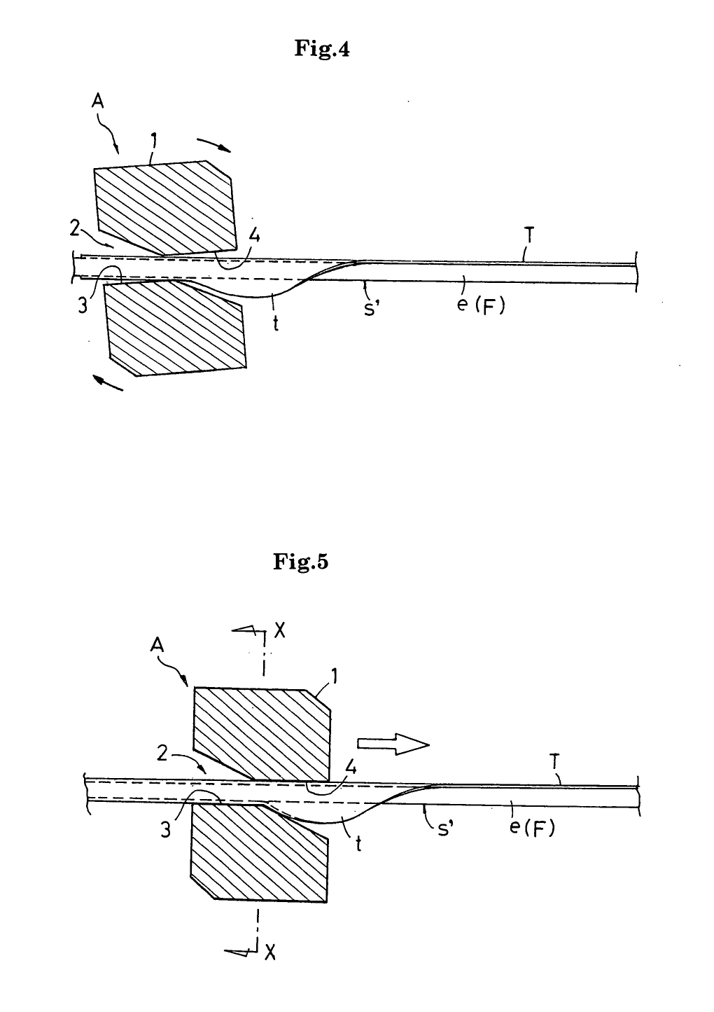

At first, as a joining preparation step, the tape portion t joined to the joining face S of the workpiece and protruded from the edge side e is folded back manually at its one end in the tape longitudinal direction to be partially joined to the back face of the edge side. The jig main body 1 of the adhesive tape joining jig A is externally fitted to and engaged with this joining portion via the guide groove 2. In this case, as shown in FIG. 4, the main body 1 is comfortably engaged with the joining portion being tilted in the back-and-forth direction so that the pressing load is not applied to the edge side e.

Next, by carrying out the twisting operation in a direction shown by an arrow in FIG. 4 of the jig main body 1, as shown in FIG. 5, the back-and-forth place of the edge side e is sandwiched from right and left by the front guide pressing part 4 and the rear second pressing part 3. In this case, the right and left posture of the jig main body 1 is stably held into the posture that is at right angles to the longitudinal direction of the workpiece F. Due to this operation, the folded tape portion t is pressed against the back face s′ of the edge side e by the second pressing part 3.

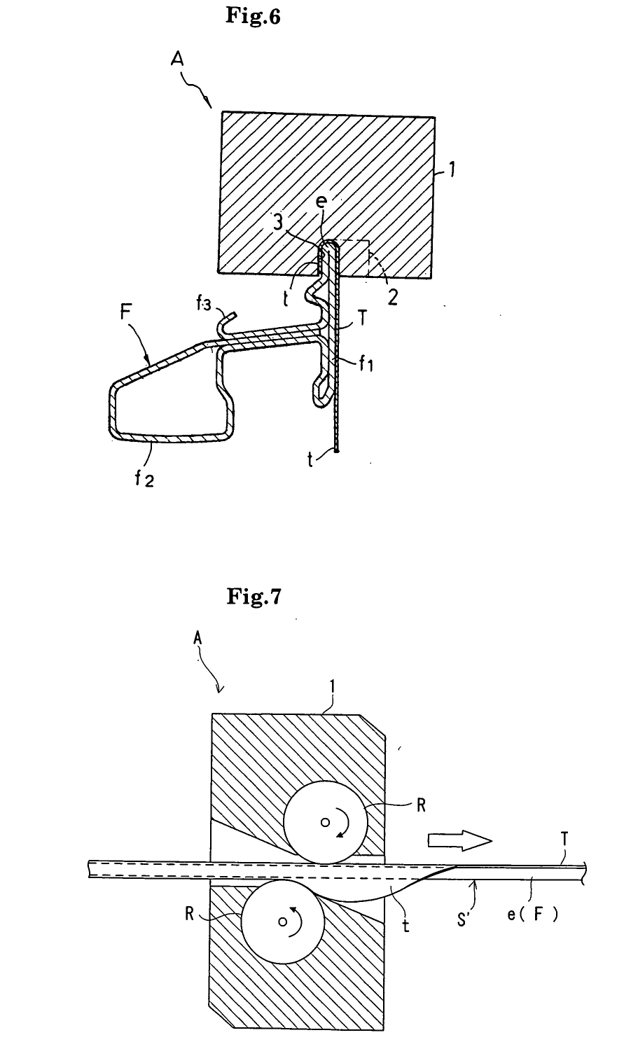

Thus, when the joining preparation is completed, as shown in FIG. 3, pressing down the jig main body 1 and pressing the first pressing part (the bottom face of the guide groove 2) 5 on the top of the edge side e, the main body 1 is pressed forward with the twisting operation shown in FIG. 4 added. Following to this operation, at first, a base part of the folded tape portion t is joined at the top of the edge side e by the first pressing part 5 at the front part from the constricted part 2a. Then, in accordance with the forward movement, the folded-back state of the tape portion t becomes gradually strong inside of the widened groove 2f to be made into a posture along the back face s′ of the edge side e. In addition, at the rear part of the constricted part 2a, as shown in FIG. 6, the tape portion t is pressed on the back face s′ of the edge side e by the second pressing 3 to be joined thereto.

In this case, since the tape portion t is pressed prior to the top of the edge side e by the first pressing part 5, air tangled into the side of the joined face in accordance with folding of the tape is pushed out to the side of the back face s′ of the edge side e to be removed. After that, by firmly joining the folded tape portion t on the back face s′ of the edge side e by the second pressing part 3, the folding and joining without remaining of air bubble will be performed.

Further, the present invention can be also made in the following manners.

(1) According to the above-described embodiment, the first pressing part 5, the second pressing part 3, and the guide pressing part 4 are configured by a flat inner face at the guide groove 2, respectively, however, as shown in FIG. 7, these pressing parts also can be configured by a roller R that can freely idle. According to this structure, the main body 1 can be smoothly moved manually with a less movement resistance. The roller R of the front part of the moving direction is equivalent to the guiding roller of the present invention, and the roller R at the rear part is equivalent to the rear part roller of the present invention.

(2) The main body 1 is configured by a right and left pair of blocks, the guide groove 2 is formed between the opposed regions thereof, and the gap between the guide groove 2 and the block can be adjusted by approaching or separating the both blocks. This makes it possible to correspond to the workpiece F with different thicknesses of the edge side e.

The present invention may be embodied in other specific forms without departing from the spirit or essential attributes thereof and, accordingly, reference should be made to the appended claims, rather than to the foregoing specification, as indicating the scope of the invention.

What is claimed is:

1. An adhesive tape joining method for folding back a protruded portion of an adhesive tape joined on an adhesive tape joining target face of a workpiece along an edge side of the workpiece and joining the protruded portion to the workpiece, the method comprising the steps of:
engaging and guiding a jig main body with and to the edge side of the workpiece to move the jig main body along the workpiece; and
folding back the tape portion protruded from the workpiece while pressing the tape portion by a first pressing part provided to the jig main body prior to a top of the edge side and, then, pressing the folded tape portion against a back face of the edge side by a second pressing part provided to the jig main body.

2. The adhesive tape joining method according to claim 1, wherein
a guide pressing part provided to the jig main body is engaged with and acted on an adhesive tape joining target face of the workpiece and, also, this guide pressing part and the second pressing part are displaced in the back and forth in the direction of moving the jig to sandwich and press the edge side of the workpiece from the both sides.

3. The adhesive tape joining method according to claim 2, wherein
the jig main body is provided with a guide groove that is externally fitted to and engaged with the edge side, this guide groove has a narrow constricted part at the back-and-forth middle part, and the guide groove is formed in the shape of a hand drum that is opened with its back-and-forth part widened,
the bottom face of the guide groove is made into the first pressing part, and this first pressing part is engaged with and acted on the adhesive tape joining target face of the workpiece,
one of the groove inside faces at the front part of the constricted part is made into the guide pressing part, and
the guide pressing part and the second pressing part are displaced in the back and forth in the direction of moving the jig to sandwich and press the edge side of the workpiece from the both sides.

4. An adhesive tape joining jig for convoluting a protruded portion of an adhesive tape joined to an adhesive tape joining target face of a workpiece along an edge side of the workpiece and joining the protruded portion to the workpiece, the jig comprising:
a first pressing part opposed to a top of an edge side, which manually moves a jig main body along the edge side being engaged with the edge side of the workpiece;
a second pressing part opposed to a back face of the edge side of the workpiece; and
a guide pressing part opposed to the adhesive tape joining target face of the workpiece, wherein
the first pressing part and the guiding pressing part are arranged at the part of the direction of moving the jig ahead of the second pressing part.

5. The adhesive tape joining jig according to claim 4, wherein
the jig main body is provided with a guide groove externally fitted to and engaged with the edge side, this guide groove has a narrow constricted part at the back-and-forth middle part, and the guide groove is formed in the shape of a hand drum that is opened with its back-and-forth part widened,
the bottom face of the guide groove is formed on the first pressing part,
one of the groove inside faces at the front part of the constricted part is formed on the guide pressing part, and
the other of the groove inside faces at the rear part of the constricted part is formed on the second pressing part.

6. The adhesive tape joining jig according to claim 5, wherein
the jig main body is configured by a pair of blocks,
a guide groove to be externally fitted to and engaged with the edge side is formed at a region where the pair of blocks are opposed each other, and
further, by approaching and separating the pair of blocks, an interval of the guide groove 2 can be adjusted.

7. The adhesive tape joining jig according to claim 4, wherein
the jig main body is formed by a fluorine resin.

8. The adhesive tape joining jig according to claim 4, wherein
the surface of the guide groove is coated with a fluorine resin.

9. The adhesive tape joining jig according to claim 4, wherein
the jig main body is provided with a guide groove externally fitted to and engaged with the edge side, this guide groove has a narrow constricted part at the back-and-forth middle part, and the guide groove is formed in the shape of a hand drum that is opened with its back-and-forth part widened,
the bottom face of the guide groove is made into the first pressing part,
further, one of the groove inside faces at the front part of the constricted part is made into a guiding roller that can freely idle,
the other of the groove inside faces at the rear part of the constricted part is provided with a rear part roller that can freely idle, and
the guiding roller and the rear part roller are displaced in the back and forth in the direction of moving the jig to sandwich and press the edge side of the workpiece from the both sides.

10. The adhesive tape joining jig according to claim 9, wherein
the jig main body and the both rollers are formed by a fluorine resin.

11. The adhesive tape joining jig according to claim 9, wherein
the surface of the guide groove and the surfaces of the both rollers are coated with a fluorine resin.
